(19) United States
(12) Patent Application Publication
(10) Pub. No.: US 2022/0183917 A1
(43) Pub. Date: Jun. 16, 2022

(54) Massage gun holder

(71) Applicant: John DeNicola, Lemoore, CA (US)

(72) Inventor: John DeNicola, Lemoore, CA (US)

(21) Appl. No.: 17/124,035

(22) Filed: Dec. 16, 2020

(51) Int. Cl. A61H 1/00

(52) U.S. Cl. CPC A61H 1/008; B33Y 80/00

(57) ABSTRACT

The disclosed device is a massage device holder and can be made as a single piece or with multiple pieces. In one embodiment the massage device holder is made up of 6 pieces. In one embodiment the massage device holder consists of a device to hold the massaging device, a backbone comprising a center piece, 2 arms and 2 legs. The massage device holder can hold many different massage devices. It may be of any shape as desired by a user, and in one embodiment has an L shaped body that at the top has a clip/strap/bolted/fastener to hold the top portion of the massager.

### BACKGROUND OF THE INVENTION

Subluxations of the vertebrae in diverse regions are known to be associated with or occur concomitantly with headaches, neck pain, neck muscle spasms, upper, mid and lower back pain to mention but a few cause and effect circumstances, and understandably has given rise to scientific chiropractic care because of the effectiveness of spinal/structural adjustments of the human body in promoting health where other methods have failed. A masseuse-administered massage is a popular practice. So also, is a self-administered massage which is the particular focus of the mode of use of the massaging device of the invention.

An ability to self-administer a massage is already well known in the patented literature. It, of necessity, requires providing a support for a massaging device and thus allowing the user to make massaging contact with the supported device. The prior art provides for mechanisms to self-massage a user, however, they are not entirely satisfactory because the bodily movements of the user, particularly laterally of the massaging surface, urges the device in corresponding lateral movement and when this occurs there is diminished relative movement at the interface of the user's back and the massaging surface and relative movement is, of course, determinative of the effectiveness of the massage being administered.

### SUMMARY

The disclosed device is a massage device holder and can be made as a single piece or with multiple pieces. In one embodiment the massage device holder is made up of 6 pieces. In one embodiment the massage device holder consists of a device to hold the massaging device, a backbone comprising a center piece, 2 arms and 2 legs. The massage device holder can hold many different massage devices. It may be of any shape as desired by a user, and in one embodiment has an L shaped body that at the top has a clip/strap/bolted/fastener to hold the top portion of the massager.

### BRIEF DESCRIPTION OF DRAWINGS

The present invention will become more fully understood from the detailed description given hereinbelow and the accompanying drawings which are given by way of illustration only, and thus are not limitative of the present invention, and wherein:

FIG. 1 is a perspective view of the device.

FIG. 2 is a perspective view of the device.

FIG. 3 is a close-up perspective view of a portion of the device.

### DESCRIPTION OF THE PREFERRED EMBODIMENTS

The disclosed device is a massage device holder and can be made as a single piece or with multiple pieces. In one embodiment the massage device holder is made up of 6 pieces. In one embodiment the massage device holder consists of a device to hold the massaging device, a backbone comprising a center piece, 2 arms and 2 legs. The massage device holder can hold many different massage devices. It may be of any shape as desired by a user, and in one embodiment has an L shaped body that at the top has a clip/strap/bolted/fastener to hold the top portion of the massager.

Both sides of the massage device holder may have foam running along them as well as the back portion to not only grip the massager into place but to dampen the noise and vibrations. At the bottom is where the massager sits, it has a wider flat base that has an adjustable tilt and can extend longer for various massagers. The backbone center piece is the main part of the structure that holds all the pieces in place. It can be of any size as desired by a user, and in one embodiment is about 1 inch wide and about ¼ inch thick. The backbone centerpiece runs vertically with a fixed center position for the massage device to sit into. The backbone can be of any length as desired, and in one embodiment may be between three and four feet in length without the fixed position to have the massage device holder clip and unclip for a quicker transition. The massage device holder may have a clamp mechanism to unclip and reattach on the backside of the massage device holder. The back side of the backbone, is typically pushed against a solid surface such as a wall or door, may have a thick foam to dampen vibrations. The 2 arms and 2 legs have their own fastening tool which may be a C-clamp, bench clamp, spring clamp, quick grip, speed clamp, Bar, F, sliding clamp, gripe clamp or other mechanism as desired by a user. Another variation is each arm and leg are connected to a solid piece that clamps the whole (left, right) side as one piece onto a structure.

Through the use of three-dimensional printing these devices may be made without a high cost of other similar devices. With the ability of the device to be moved from one location to another, the device can be used to massage almost any part of a body as desired by a user. The body parts to be massaged include, but are not limited to, the front of a body like the chest, shoulders, biceps, quads, calves, etc. This device is especially useful to specific fitness groups that enjoy getting a great massage without having to spend money or go anywhere. The device is easily storable but exceptionally durable and can be setup quickly and used to get a massage right away.

The device may need a sturdy base that will be pushed against a doorframe to ensure safety but also help keeping the massage consistent with the pressure applied against the device. The device needs to be able to either: move freely so you are able to move from point to point (up and down) or a clip system that is methodically thought out so there is fluidity from position to position.

Traditional 3D printing has limitations in the manufacturing process, so if the device is printed with 3D printing, the final product could be a mix of hard plastic with a metal bracket/clamp.

The device allows a user to massage the backside of their body. All “fitness” massage devices allow you to use the massager freely with a user's hands for any body part they can reach. Even if a user is exceptionally flexible, they cannot typically reach their rear deltoids, trapezius, rhomboid major/minor, teres major/minor, etc. These muscles are normally only “massaged” with a foam roller or ball. This device solves these problems.

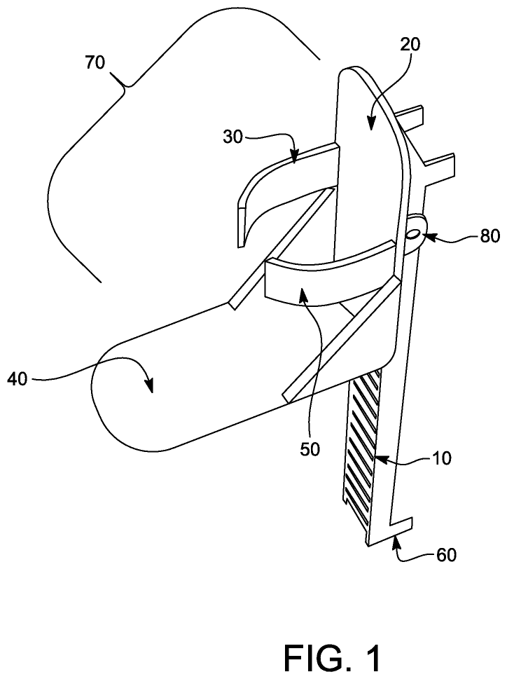

Turning now to FIG. 1 it shows the device in a top, perspective view. The backbone of the device, 10, is shown with the massage device holder, 70, attached to the backbone, 10. The massage device holder, 70, has a massage device holding platform, 40, that can support the weight of a massage device (not pictured). The massage device holder, 70, also has a back, 20, a left securing arm, 30, a right securing arm, 50, that are designed to hold a plurality of different massage devices in place in the massage device holder. The device has attachment points, 80, to secure the massage device holder, 70, to the backbone, 10. The backbone, 70, also has feet, 60, to help stabilize and support the backbone, 10, and massage device holder, 70.

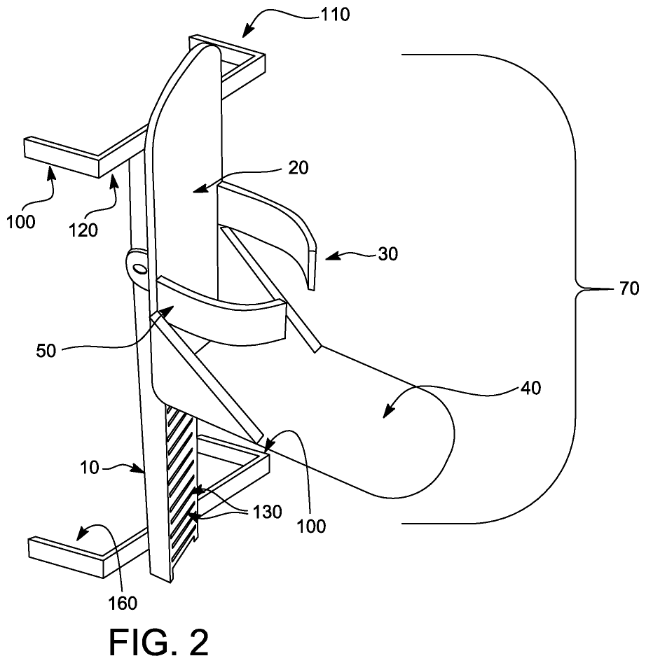

Turning now to FIG. 2, it shows a second perspective view of a different embodiment of the device. The backbone, 10, remains similar to the embodiment shown in FIG. 1. In FIG. 2 it can be seen that the backbone, 10, has a series of ridges, 130, that are used to support the massage holder device, 70, securely in place. The massage device holder, 70, has a massage device holding platform, 40, that can support the weight of a massage device (not pictured). The massage device holder, 70, also has a back, 20, a left securing arm, 30, a right securing arm, 50, that are designed to hold a plurality of different massage devices in place in the massage device holder.

Further FIG. 2 shows a second embodiment of a support system for the backbone, 70. Attached to the bottom of the backbone, 70, is a foot support device, 150, and attached to the foot support device is a left foot, 140, and a right foot, 160. At the top of the backbone is an upper support device, 120, to which is attached a right upper support arm, 100, and a left upper support arm, 110. These upper support arms can be used to attach the backbone to a solid surface, pole, wood block, or other object to hold the backbone in place.

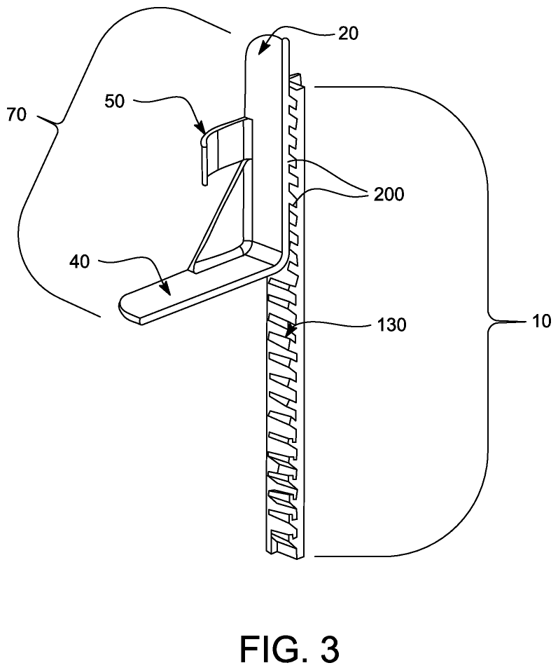

Turing now to FIG. 3, which shows a close-up perspective view of how the massage holder device, 70, attaches to the backbone, 10. The backbone has a plurality of ridges, 130, that are angled upward. The angle, size, and depth of the ridges may vary between devices depending the usage requirements. The back plate, 20, of the massage holding device, 70, which, in FIG. 3, also partially shows the device holding platform, 40, and the right securing arm, 50. On the back of the device, is a second plurality of ridges, 200, that extend downward and are of a complimentary size to the backbone ridges, 130, such that the second plurality of ridges, 200, can be inserted into the backbone ridges, 130, to hold the massage holder device, 70, securely in place. These ridges can be of any size or geometry such that they can be inserted into on another and hold the massage holder device, 70, securely in place.

As previously stated, the device can be manufactured with a Three-Dimensional Printing material system. In these systems it is desired to have good depowderablility, sufficient strength, and a quick solidification mechanism when preparing a mold or an appearance model. As used herein, the term “depowderability” is defined as the ability to clean loose powder from a printed article after it has solidified. While the exemplary embodiments described herein are particularly advantageous for molds because of their strength, heat resistance and other characteristics, they can also be used to make appearance models and other articles.

The present invention can be created using a three-dimensional printing material system comprising a mixture of a first particulate material, a second particulate material, a third particulate material, and a filler. A fluid causes the first particulate material and the second particulate material to react to form a solid in a first period of time, and causes the third particulate material to solidify in a second period of time that is longer than the first period of time. The reaction between the first particulate material and the second particulate material provides initial strength to the printed part during and after the printing process and may promote high accuracy, allow for a shorter time from the end of the print stage to handling and may reduce or eliminate part deformation. Solidification of the third particulate material provides strength to the final product. As used herein, the term “solid” is intended to mean a substance that has a definite volume and shape and resists forces that tend to alter its volume or shape, as well as to include solid-like substances, such as gels.

According to traditional three-dimensional printing, a layer or film of particulate material is applied on a downwardly movable surface of a container. The layer or film of particulate material can be formed in any manner, and preferably is applied using a counter-roller. The particulate material applied to the surface includes a first particulate material, a second particulate material, a third particulate material, and a filler. As used herein, “filler” is meant to define an inert material that is solid prior to application of the fluid, which is substantially insoluble in the fluid, and which gives structure to the final article. The first and second particulate materials react in the presence of a fluid to provide initial bond strength to the part being built, while the third particulate material solidifies in a longer period of time to provide final part strength.

For purposes of the present invention, “particulate material” is meant to define any dry material containing significant amounts of particulate material. The particulate material may be soluble in, or interact with the fluid material, or any portion thereof, depending upon the particular embodiment of the invention that is being practiced. For example, in certain embodiments, it may be desirable that the particulate material dissolve in the fluid material.

Generally, the size of the particles in the particulate material is limited by the thickness of the layers to be printed. That is, the particles are preferably approximately smaller than the thickness of the layers to be printed. The particulate materials may have any regular or irregular shape. Using smaller particles may provide advantages such as smaller feature size, the ability to use thinner layers, and the ability to reduce what is known in the art as a “stair stepping” effect. In preferred embodiments, the material systems include particulate material having particles with a mean diameter ranging from about 1 μm to about 300 μm, preferably ranging from about 2 μm to about 250 μm, more preferably ranging from about 10 μm to about 100 μm, and more preferably ranging from about 10 μm to about 50 μm.

The particulate material may include impurities and/or inert particles. The inert particles or any portion of the particulate material can comprise granular, powdered or fibrous materials. Classes of inert particles include a polymer, a ceramic, a metal, an organic material, an inorganic material, a mineral, clay and a salt.

Choosing a suitable particulate material for the material systems of the present invention involves various qualitative evaluations, which may easily be accomplished through routine experimentation by those of ordinary skill in the art. First, a small mound of particulate material is formed, a small depression is formed in the mound, and a small amount of fluid is placed in the depression. Visual observations are made regarding, among other things, the rate at which the fluid diffuses into the particulate material, the viscosity of the particulate material introduction of the fluid, and whether a membrane is formed around the fluid. Next, line testing is performed by filling a syringe filled with fluid and strafing the mounds of particulate material. After a period of about 24 hours, the mounds of particulate material are examined. Those in which pebbles of particulate material have formed are suitable, as it means that the particulate material and fluid react more quickly than the fluid can evaporate or diffuse into the surrounding dry powder. Those in which both pebbles and rods of hardened material have formed are the yet more suitable, indicating that the rate at which the fluid and particulate material harden is greater than the rate at which fluid evaporates or diffuses into the surrounding dry powder. In some instances, the rods of hardened material will shrink, indicating that the particulate material may give rise to problems with distortions. As described above, various additives may be included in the particulate material and/or fluid to accelerate the rate at which the particulate material hardens.

The particulate material may also be evaluated to determine the ease of spreading. Simple test parts may also be formed to determine, inter alias, the flexural strength, the distortion, the rate of hardening, the optimum layer thickness, and the optimum ratio of fluid to particulate material. Material systems suitable for use in the three-dimensional printing method include those hardening with minimal distortion, in addition to relatively high flexural strength. Hardened products with high flexural strength values may not be suitable for use in the three-dimensional printing method, if distortions compromise the accuracy of the final printed articles; this is especially applicable where relatively fine features are desired.

After a material has been identified as a potential material through line testing, the formula may be further developed by printing test patterns on a three-dimensional printer. The strength, accuracy, and degree of difficulty in handling may all be characterized with a set of test parts (e.g., breaking bars for strength and gauge blocks for accuracy). These tests may be repeated as much as necessary, and powder formulas are iterated until optimum characteristics are obtained.

According to aspects of embodiments of the present invention, an additional criterion for selecting the particulate materials are the relative rates of reaction and/or solidification in the presence of a fluid. The first particulate material and the second particulate material are selected to react and solidify in the presence of the fluid in a period of time shorter than the solidification of the third particulate material in the presence of the fluid. Solidification of the reaction product of the first and second particulate materials in the presence of the fluid could occur within about 20 minutes. In another embodiment, the first particulate material and the second particulate material react to form a solid within about 10 minutes, preferably within about 5 minutes, more preferably within about 2 minutes, and most preferably within about 1 minute of application of the fluid. The solidification of the third particulate material occurs at a time longer than the reaction between the first particulate material and the second particulate material. In one embodiment, the third particulate material solidifies in a time ranging from about 10 minutes to about 2 hours or more. The absolute period of time for the solidification of the first and second particulate materials and the absolute period of time for solidification of the third particulate material can each vary over a wide range, however, the period of time for solidification of the third particulate material will be at least longer than period of time for solidification of the first particulate material and the second particulate material.

In one embodiment, the first particulate material may be an acid and second particulate material may be a base that react with one another in the presence of a fluid. For example, the first particulate material may be a phosphate while the second particulate material may be an alkaline oxide, and/or an alkaline hydroxide. When an aqueous fluid is printed on a powder that contains these materials, the phosphate dissolves and acts on the alkaline oxide and/or an alkaline hydroxide to form a cement.

The phosphates used in the embodiments of the invention include a salt of an oxygen acid of phosphorus including salts of phosphoric acids such as orthophosphoric acid, polyphosphoric acid, pyrophosphoric acid, and metaphosphoric acid.

As used herein, the term “phosphate” is generic and includes both crystalline and amorphous inorganic phosphates. Further, “phosphate” includes, but is not limited to, orthophosphates and condensed phosphates. Orthophosphates are compounds having a monomeric tetrahedral ion unit (PO₄)³⁻. Typical orthophosphates include sodium orthophosphates, such as, monosodium phosphate, disodium phosphate, trisodium phosphate, potassium orthophosphates and ammonium orthophosphates.

Examples of acid phosphates that may be used in embodiments of the invention include, but are not limited to, monoammonium phosphate; sodium aluminum phosphate, acidic; monocalcium phosphate, anhydrous; monopotassium phosphate; monosodium phosphate; and aluminum acid phosphate. Examples of acid polyphosphates that may be used in embodiments of the invention include, but are not limited to, sodium tripolyphosphate; sodium hexametaphosphate; sodium polyphosphate, anhydrous; and ammonium polyphosphate. Examples of acid pyrophosphates that may be used in embodiments of the invention include, but are not limited to, sodium acid pyrophosphate; tetrasodium pyrophosphate; tetrapotassium pyrophosphate. Examples of other phosphates that may be used in embodiments of the invention include, but are not limited to, diammonium phosphate; dipotassium phosphate; disodium phosphate; monocalcium phosphate, monhydrate; dicalcium phosphate, dihydrate; dicalcium phosphate, anhydrous; tricalcium phosphate; disodium phosphate; and tripotassium phosphate. In a preferred embodiment, the phosphate is a phosphate salt, such as, monocalcium phosphate, anhydrous; sodium aluminum phosphate, acidic; aluminum acid phosphate; monoammonium phosphate; monopotassium phosphate; and combinations thereof.

Alkaline oxides that may be used as the second particulate material include, but are not limited to, zinc oxide; magnesium oxide; calcium oxide; copper oxide; beryllium oxide; bismuth oxide; cadmium oxide; tin oxide; red lead oxide; and combinations thereof. Examples of alkaline hydroxides that may be used as the second particulate material include, but are not limited to, magnesium hydroxide, beryllium dihydroxide, cobalt trihydroxide, and combinations thereof. In one embodiment, the second particulate material is an alkaline oxide. In a preferred embodiment, the alkaline oxide is magnesium oxide. Magnesium oxide may react with phosphate compounds to form magnesium phosphate cement. In one embodiment, the ratio of magnesium oxide and acid phosphate salt may be varied to accommodate a variety of resin, filler, and binder chemistries.

In another embodiment, magnesium oxide may react with sulfate containing compounds to form magnesium oxysulfate cement or react with chloride containing compounds to form magnesium oxychloride cement. In another embodiment, zinc oxide may react with sulfate containing compounds or chloride containing compounds. Examples of sulfate containing compounds include, but are not limited to, magnesium sulfate and zinc sulfate. Examples of chloride containing compounds include, but are not limited to, magnesium chloride, zinc chloride, and calcium chloride.

In another embodiment, the first particulate material may be plaster, and the second particulate material may be an accelerator. Plaster is frequently called “Plaster of Paris,” a name derived from the earths of Paris and its surrounding regions, which contain an abundance of the mineral gypsum, from which Plaster of Paris is manufactured. Plaster is also referred to by many other names, including, but not limited to, sulphate of lime, semihydrate of calcium sulfate, casting plaster, gypsum plaster, hydrated sulphate of lime, hydrated calcium sulphate, and dental plaster, as well as a variety of trade names. The term “plaster,” as used herein, is meant to define any variety of material including a substantial amount of CaSO₄.½H₂O that is in powder form prior to the application of an aqueous fluid. The terms “hydrated plaster” and “set plaster” are used interchangeably herein and are meant to include any variety of plaster that includes a substantial amount of CaSO₄.2H₂O after setting, or rehydration. Many varieties of plaster are commercially available, varying, for example, in structural strength, the time required for setting, and in volume changes that occur during the setting. Typically, commercially available plasters include other ingredients such as, but not limited to, silica, powdered limestone, starch, Terra Alba, and lime. Examples of commercially available plaster materials that may be suitable for the embodiments of the present invention include, but are not limited to, white hydrocal cement, durabond 90, and drystone (each available from U.S. Gypsum, located in Chicago, Ill.), as well as most brands of casting plaster, molding plaster, and spackling compound.

An accelerator may be used as the second particulate material. “Accelerator,” as used herein, is meant to define any material that increases the rate at which plaster sets. Examples of ways to accelerate the rate of plaster include, but are not limited to, increasing the solubility of plaster in water, by providing additional nucleation sites for crystal formation or increasing the growth rate of crystals. Accelerators are generally used sparingly in conventional plaster processing, as they may adversely affect the strength characteristics of the plaster. However, accelerators are preferred in some embodiments of the present invention because they help produce a relatively quick set during printing and further processing. The potential adverse effect to the strength characteristics of the plaster is of less importance since the third particulate material is present to provide strength to the final part. Suitable accelerators include, but are not limited to, Terra Alba, potassium sulfate, barium sulfate, ammonium sulfate, sodium chloride, under calcined-plaster, alum, potassium alum, lime, calcined lime, and combinations thereof. Terra Alba, which is raw ground gypsum, is a preferred accelerator, and works by providing additional nucleation sites for gypsum crystal formation.

Another preferred accelerator is potassium sulfate, which is thought to work by increasing the solubility of the plaster in the water. Both Terra Alba and potassium sulfate also increase the final strength of the article. In one embodiment, at least one accelerator is preferably used as a second particulate material in order to increase the rate at which the plaster sets. The third particulate material of the embodiments of the invention reacts in the presence of an fluid to solidify at a rate slower than that of the reaction between the first particulate material and the second particulate material, and imparts strength to the final part. In one embodiment, the third particulate material is an adhesive. In another embodiment, the third particulate material is a filler coated with an adhesive.

The adhesive is a compound selected for the characteristics of high solubility in the fluid, low solution viscosity, low hygroscopicity, and high bonding strength. The adhesive should be highly soluble in the fluid in order to ensure that it is incorporated rapidly and completely into the fluid. Low solution viscosity is preferred to ensure that once dissolved in the fluid, the solution migrates quickly to sites in the powder bed to adhesively bond together the reinforcing materials. The adhesive is preferably milled as finely as possible prior to admixture with the filler and/or prior to coating the filler particles in order to increase the available surface area, enhancing dissolution in the solvent, without being so fine as to cause “caking,” an undesirable article characteristic. Typical adhesive particle grain sizes are about 10-40 μm. Low hygroscopicity of the adhesive avoids absorption of excessive moisture from the air and evaporating fluid in printed regions of the powder bed which causes “caking”, in which unactivated powder spuriously adheres to the outside surface of the part, resulting in poor surface definition.

Water-soluble compounds are preferred for the adhesive in embodiments of the present invention, although other compounds can be used. Compounds suitable for use as the adhesive in embodiments of the present invention may be selected from the following non-limiting list: water-soluble polymers, carbohydrates, sugars, sugar alcohols, proteins, and some inorganic compounds. Water-soluble polymers with low molecular weights dissolve more quickly because smaller molecules diffuse more rapidly in solution. Suitable water-soluble polymers include but are not limited to, polyethylene glycol, sodium polyacrylate, polyacrylic acid, polyvinyl alcohol, polyvinyl pyrrolidone, sodium polyacrylate copolymer with maleic acid, polyvinyl alcohol copolymer with polyvinyl acetate, and polyvinyl pyrrolidone copolymer with vinyl acetate, a copolymer of octylacrylamide/acrylate/butylaminoethyl methacrylate, polyethylene oxide, sodium polystyrene sulfonate, polyacrylic acid, polymethacrylic acid, copolymers of polyacrylic acid and methacrylic acid with maleic acid, and alkali salts thereof, maltodextrine, hydrolyzed gelatin, sugar, polymethacrylic acid, polyvinyl sulfonic acid, sulfonated polyester, poly(2-ethyl-2-oxazoline), polymers incorporating maleic acid functionalities, and combinations thereof. Carbohydrates include, but are not limited to, acacia gum, locust bean gum, pregelatinized starch, acid-modified starch, hydrolyzed starch, sodium carboxymethylcellulose, sodium alginate and hydroxypropyl cellulose. Suitable sugars and sugar alcohols include sucrose, dextrose, fructose, lactose, polydextrose, sorbitol and xylitol. Organic compounds including organic acids and proteins can also be used, including citric acid, succinic acid, polyacrylic acid, gelatin, rabbit-skin glue, soy protein, and urea. Inorganic compounds include plaster, bentonite, sodium silicate and salt.

In another embodiment, a mixture of solid material is contacted by a fluid, and undergoes a first solidification beginning with the fluid contact and occurring at a first rate, and also undergoes a second solidification reaction beginning with the fluid contact and occurring at a second rate slower than the first rate. As used herein, the term “solid material” includes particulate material, aggregates, and the like. In one embodiment of the invention, a solid material may include more than one type of material, such as, a particulate material having a coating that is activated by the fluid causing a solidification reaction to occur within the solid material and among adjacent solid material. As used herein, the term “solidification reaction” is defined as any chemical, thermal, or physical process wherein free flowing solid material are hardened, bonded, or firmly fixed in relation to other adjacent solids.

In one embodiment, the mixture may be a mixture of two solid materials, wherein one of the solid materials is present in excess of a quantity that will react with the other solid material. In this embodiment, when contacted by a fluid, the two solids materials react and solidify in a first period of time, and the excess of one of the solid materials left over from the reaction with the other solid material reacts when contacted by a fluid in a second period of time that is longer than the first period of time. For example, the mixture may comprise an alkaline oxide, such as magnesium oxide, and at least one of polyacrylic acid, polymethacrylic acid, copolymers of polyacrylic acid and methacrylic acid with maleic acid, and alkali salts thereof. In the presence of a fluid, the alkaline oxide reacts with a portion of the at least one of polyacrylic acid, polymethacrylic acid, citric acid, succinic acid, malic acid, copolymers of polyacrylic acid and methacrylic acid with maleic acid, and alkali salts thereof to form a solid. The remaining portion of the at least one of polyacrylic acid, polymethacrylic acid, citric acid, succinic acid, malic acid, copolymers of polyacrylic acid and methacrylic acid with maleic acid, and alkali salts thereof left over from the reaction with the alkaline oxide may then solidify in the presence of a fluid in a longer period of time.

In another embodiment, the mixture may comprise two solids, wherein one solid material solidifies in the presence of a fluid in one period of time, while the other particulate material solidifies in the presence of a fluid in a second period of time that is longer than the first period of time.

In another embodiment, the mixture may comprise three solid materials, wherein a first and second solid material react in the presence of a fluid to form a solid in one period of time, and the third solid material solidifies in the presence of a fluid in a longer period of time. In an alternative embodiment, a first solid material may solidify in the presence of a fluid in one period of time, and a second solid material and third solid material may react to form a solid in the presence of a fluid in a second period of time that is longer than the first period of time.

In another embodiment, the mixture may comprise a first coated particulate material and a second particulate material. In one embodiment, the first coated particulate material reacts to form a solid in one period of time when contacted by a fluid and the second particulate material solidifies when contacted by a fluid in longer period of time. In another embodiment, a first coated particulate material reacts to form a solid in one period of time when contacted by a fluid and a second particulate material solidifies when contacted by a fluid in a shorter period of time. In another embodiment, one or more particulate material may be encapsulated, or present in an aggregate.

The fluid in embodiments of the present invention is selected to comport with the degree of solubility required for the various particulate components of the mixture, as described above. The fluid comprises a solvent in which the third particulate material and at least one of the first particulate material and the second particulate material are active, preferably soluble, and may include processing aids such as a humectant, a flowrate enhancer, and a dye. An ideal solvent is one in which the third particulate material and at least one of the first particulate material, the second particulate material, and the third particulate material is highly soluble, and in which the filler is insoluble or substantially less soluble. The fluid can be aqueous or non-aqueous. In a preferred embodiment, an aqueous fluid comprises at least one cosolvent. Suitable solvents and cosolvents may be selected from the following non-limiting list: water; methyl alcohol; ethyl alcohol; isopropyl alcohol; acetone; methylene chloride; acetic acid; ethyl acetoacetate; dimethylsulfoxide; n-methyl pyrrolidone; 2-amino-2-methyl-1-propanol; 1-amino-2-propanol; 2-dimethylamino-2-methyl-1-propanol; N,N-diethylethanolamine; N-methyldiethanolamine; N,N-dimethylethanolamine; triethanolamine; 2-aminoethanol; 1-[bis[3-(dimethylamino)propyl]amino]-2-propanol; 3-amino-1-propanol; 2-(2-aminoethylamino)ethanol; tris(hydroxymethyl)aminomethane; 2-amino-2-ethyl-1,3-propanediol; 2-amino-2-methyl-1,3-propanediol; diethanolamine; 1,3-bis(dimethylamino)-2-propanol; and combinations thereof. Other polar organic compounds will be obvious to one skilled in the art. In a preferred embodiment, the fluid is an aqueous solution of 2-amino-2-methyl-1-propanol, with isopropanol, ethanol, or a combination of both.

The filler in embodiments of the present invention is a compound selected for the characteristics of insolubility, or extremely low solubility in the fluid, rapid wetting, low hygroscopicity, and high bonding strength. The filler provides mechanical structure to the hardened composition. Sparingly soluble filler material may be used, but insoluble filler material is preferred. The filler particles become adhesively bonded together when the first particulate material and the second particulate material interact upon application of the fluid. The filler particles are further bonded together when the third particulate material dries/hardens after the fluid has been applied. Preferably, the filler includes a distribution of particle grain sizes, ranging from the practical maximum of about 250-300 μm downward, to the practical minimum of about 1 μm. Large grain sizes appear to improve the final article quality by forming large pores in the powder through which the fluid can migrate rapidly, permitting production of a more homogeneous material. Smaller grain sizes serve to reinforce article strength.

Compounds suitable for use as the filler in embodiments of the present invention may be selected from the same general groups from which the third particulate material is selected, provided that the solubility, hygroscopicity and bonding strength criteria described above are met. Examples of fillers include, but are not limited to, limestone, olivine, zircon, alumina, staurolite, and fused silica. In one embodiment, the filler may be a granular refractory particulate, including, but not limited to, limestone, staurolite, silica sand, zircon sand, olivine sand, chromite sand, magnesite, alumina silicate, calcium silicate, fused silica, calcium phosphate, rutile, bentonite, montmorillonite, glass, chamotte, fireclay, and mixtures thereof. In a preferred embodiment, the filler is olivine, a mineral used for foundry sand ((Mg—Fe)₂SiO₄) that is low in crystalline silica and possesses a low coefficient of thermal expansion. In another preferred embodiment, the filler is zircon (ZrSiO₄).

As used herein, “activates” is meant to define a change in state from essentially inert to adhesive. When the fluid initially comes into contact with the particulate mixture, it immediately flows outward (on the microscopic scale) from the point of impact by capillary action, dissolving the adhesive within the first few seconds. A droplet of fluid, typically having a volume of about 100 pl, may spread to a surface area of about 100 μm once it comes into contact with the particulate mixture. As the solvent dissolves the third particulate material and at least one of the first particulate material and second particulate material, the fluid viscosity increases dramatically, arresting further migration of the fluid from the initial point of impact. Within a few minutes, the fluid with dissolved particulate material therein infiltrates the less soluble and slightly porous particles, forming bonds between the filler particles. The fluid is capable of bonding together the particulate mixture in an amount that is several times the mass of a droplet of the fluid. As volatile components of the fluid evaporate, the adhesives harden, joining the filler into a rigid structure, which becomes a cross-sectional portion of the finished article.

Any unactivated particulate mixture that was not exposed to the fluid remains loose and free flowing on the movable surface. Preferably, the unactivated particulate mixture is left in place until formation of the final article is complete. Leaving the unactivated, loose particulate mixture in place ensures that the article is supported during processing, allowing features such as overhangs, undercuts, and cavities (not illustrated, but conventional) to be defined without using support structures. After formation of the first cross-sectional portion of the final article, the movable surface is indexed downward.

Using, for example, a counter-rolling mechanism, a second film or layer of the particulate mixture is then applied over the first, covering both the rigid first cross-sectional portion, and any loose particulate mixture by which it is surrounded. A second application of fluid follows in the manner described above, dissolving the adhesive and forming adhesive bonds between a portion of the previous cross-sectional portion, the filler, and, optionally, fiber of the second layer, and hardening to form a second rigid cross-sectional portion added to the first rigid cross-sectional portion of the final article. The movable surface is again indexed downward.

Applying a layer of particulate mixture, including the adhesive, applying the fluid, and indexing the movable surface downward are repeated until the final article is completed.

Those skilled in the art will readily appreciate that all parameters listed herein are meant to be exemplary and actual parameters depend upon the specific application for which the methods and materials of the present invention are used. It is, therefore, to be understood that the foregoing embodiments are presented by way of example only and that, within the scope of the appended claims and equivalents thereto, the invention can be practiced otherwise than as specifically described.

While several embodiments of the invention have been described and illustrated herein, those of ordinary skill in the art will readily envision a variety of other means and structures for performing the functions and/or obtaining the results or advantages described herein, and each of such variations or modifications is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims (as well as in the specification above), all transitional phrases such as “comprising”, “including”, “carrying”, “having”, “containing”, “involving”, and the like are to be understood to be open-ended, i.e. to mean including but not limited to. Only the transitional phrases “consisting of” and “consisting essentially of” shall be closed or semi-closed transitional phrases, respectively, as set forth in the United States Patent Office Manual of Patent Examining Procedures, section 2111.03.

What is claimed is:

1. An attachment system for securing a treatment member comprising
a backbone, wherein the backbone defines a longitudinal axis and vertical axis and has a top, bottom, front, and back, and Wherein the bottom of the backbone has at least one securing device to secure the backbone in a vertical position and Wherein the front of the backbone contains a plurality of upwardly extending ridges;
a treatment device holder comprising a back plate, a treatment device holding platform, and a plurality of securing arms, wherein the back plate has a front and a back wherein the back has a plurality of downwardly extending ridges and wherein the treatment device holder platform is essentially perpendicular to the backbone and wherein the plurality of securing arms will securely hold a treatment device.

2. The attachment system of claim 1 wherein the backbone and back plate can be further secured to each other by screws, bolts, clips, plugs, and other means.
